(19) United States
(12) Patent Application Publication
(10) Pub. No.: US 2018/0221785 A1
(43) Pub. Date: Aug. 9, 2018

(54) METHOD AND APPARATUS FOR MAKING GROUND FOG

(71) Applicant: Mario TOMAZETICH, Himberg (AT)

(72) Inventor: Mario TOMAZETICH, Himberg (AT)

(21) Appl. No.: 15/748,192

(22) PCT Filed: Aug. 1, 2016
(86) PCT No.: PCT/AT2016/060023

§ 371 Date: Jan. 28, 2018

(30) Foreign Application Priority Data
Jul. 31, 2015 (AT) A 50692/2015

(51) Int. Cl. A63J 5/02; B01F 3/04; B05B 17/06

(52) U.S. Cl. CPC A63J 5/025; B05B 17/0607; B01F 3/04007

(57) ABSTRACT

A method for producing low lying fog as a special effect, for example in stagecraft, comprises the step of enriching the fog that emerges from a fog machine with water. The fog is wetted with water, mixed and approximately saturated. For this purpose, finely atomized water having a droplet size of 2μ to 10μ can be used. A corresponding device comprises a mixing zone (6), in particular a mixing chamber (7, 13, 20) connected to the fog machine (1), and a fan (2, 11, 19) having a downstream atomizer (3, 12, 18), e.g. an ultrasonic atomizer for water. The fog is mixed with the enriched air stream, if necessary in a counter-current, and reaches the open air as a heavy low lying fog via a water separator (14) and possibly a cooling unit (17).

The invention relates to a method and apparatus for making ground fog as an effect, in the area of stagecraft for example, with a fog machine that vaporizes a fog fluid, for example a glycol-based fog fluid.

Known fog machines vaporize a fog fluid, which meets the given demands in different compositions and together with the setting parameters of the machines. For instance, the duration and density as well as the flow rate can be set and varied. Stage fog is also used in fire extinguishing exercises in order to simulate smoke, thus enabling training on protective respirators to be performed in a realistic environment. For ground fog that brings about or supports stage effects in the manner of a foam carpet, dry ice, specifically solid, deep-cooled CO₂, is used. When dry ice vaporizes at room temperature, a very attractive, uniform, and long-lasting layer of fog forms on the ground, the staging of which can be even better enhanced using lighting effects. The procurement and cooling of sufficient quantities of dry ice is problematic and expensive. Liquid nitrogen has also been used for this purpose, but it must also be cooled. Fog produced from vaporizing dry ice displaces the atmospheric oxygen, resulting in possible respiratory discomfort and headaches in people. This fog also has an effect on the voice, which is disadvantageously altered upon extended exposure to dry ice fog due to drying in the throat. Neither CO₂ nor nitrogen are beneficial to health. The effect that can be achieved with dry ice can also be approximately produced using vaporizing fog machines with a cooling stage arranged downstream.

Independently of fog generation, so-called “hazers,” fans with ultrafine water droplets, are known which are used for cooling the airflow on hot days. These cool the airstream off and have a positive influence on people's perception in extreme heat.

It is the object of the invention to provide a method and an apparatus for producing an effective ground fog that is long-lasting, in no way injurious to health, and is perceived as pleasant by singers, actors, musicians, and the audience. This is achieved by enriching the fog with water inside or outside of the fog machine. It is especially advantageous, for the purpose of water-enrichment, to guide the fog flowing under pressure out of a fog machine through a water bath, out of which the fog rises again and is blown out. It has proven to be especially effective if water droplets, preferably finely atomized water droplets having a droplet size of 2 m to 10 m that hold the fog on the ground, are added to the fog from the fog machine for water enrichment. An apparatus for carrying out the method is characterized in that a mixing zone for mixing the fog with water droplets from a water atomizer, particularly from an ultrasonic atomizer, is downstream from the fog machine. These ultrafine water droplets adhere to the fog molecules, stabilizing them and holding them on the ground. Even if such a ground fog flows in an orchestra pit and then continues into the audience, no unpleasant odor at all is perceived. This fog is perceived as refreshing. What is more, this fog even has a positive influence on singers' vocal cords.

One special embodiment of the apparatus is characterized in that the fog formed in the fog machine is guided into the intake area of a fan in whose overpressure airstream the water atomizer or water atomizers, particularly one or more ultrasonic atomizers, are provided in the center of the fan or in the vicinity thereof. As a result of the water component already contained in the airstream, the mixing is accelerated and the fog emerges immediately at a commensurately adjustable speed. If the individual parameters such as fog quantity, flow speed, and water content are to be set separately, then it is advantageous if the mixing zone is a mixing chamber and has a respective inlet for the fog machine and for a forced airstream from a fan, and if the airstream and the fog in the mixing chamber are guided via the water atomizer and via at least one downstream baffle for water separation. Three streams thus converge here in the mixing chamber, namely the standard fog from a vaporizing fog machine, water droplets whose quantity and size are adjustable in a rising cloud from an ultrasonic atomizer, for example, and finally the speed-regulatable airstream of the fan. These streams are mixed in an especially thorough and effective manner if they meet one another in the mixing chamber at sharp angles, optionally come into contact with the water droplets of the atomizer in the counterflow, and then emerge from the mixing chamber as a homogeneous, water-enriched ground fog. The mixing chamber contains a baffle before the fog leaves the mixing chamber. This acts as a water separator, must be flowed over, and removes excess water from the fog. The height and inclination are adjustable in order to achieve the desired water content in the fog. The excess water goes directly to the atomizer and is thus beneficially reused.

As mentioned previously, the water atomizer can be associated directly with the fan that is at the outlet of a fog machine from which the finished ground fog then emerges. However, the fan with atomizer can also blow the water-enriched air into a mixing chamber into which the fog of a fog machine also travels. The mixing chamber contains at least one baffle for the purpose of separating off excess water. After the baffle, the finished ground fog comes out. It is advantageous if a cooler is integrated into the mixing zone and/or the mixing chamber and/or is downstream from the mixing chamber. This measure supports the formation of ground fog. One especially effective exemplary embodiment is characterized in that Peltier elements are provided following at least one baffle, particularly between a plurality of baffles that are arranged so as to be spaced apart from one another and, with opposing baffles that dip into the interspaces, form a labyrinth.

Embodiments of the object of the invention are shown schematically in the drawings, in which:

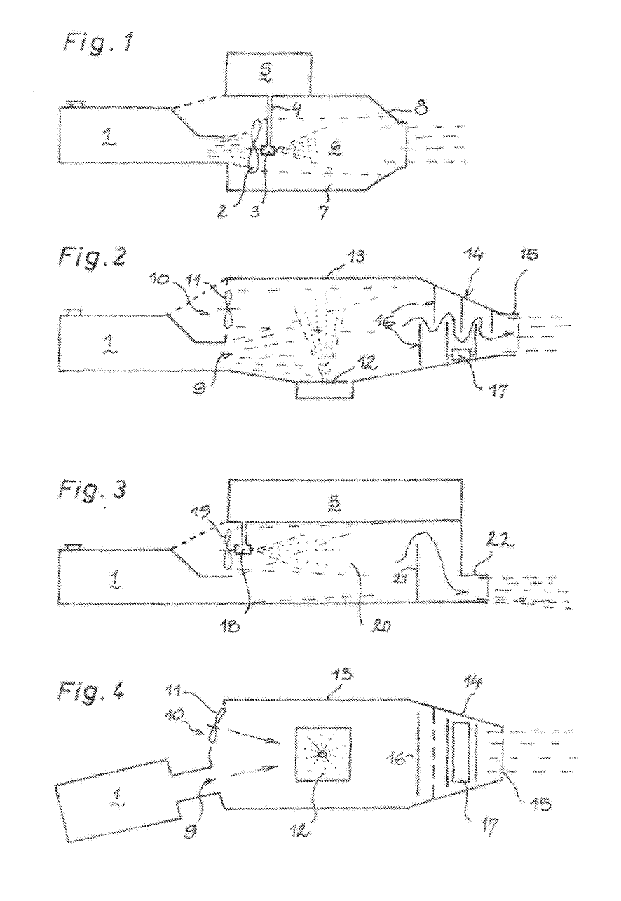

FIG. 1 is shows a schematic view of a first variant,

FIG. 2 is a schematic view of a second variant,

FIG. 3 is a schematic view of a third variant, and

FIG. 4 is a schematic plan view of an alternative embodiment according to FIG. 2.

All of the embodiments start from a standard fog machine 1. These apparatuses usually operate on the basis of a vaporizer and have a tank for a fog fluid. According to FIG. 1, a fan 2 is downstream from the outlet of the fog machine 1 and accelerates the fog from the fog machine 1 as needed and in whose overpressure area a water atomizer 3 is arranged. The latter is fed via a conduit from a water reservoir 5. The water atomizer 3 can be a spray nozzle if the water is fed in and/or suctioned out at superatmospheric pressure. It is especially advantageous, however, if the water atomizer 3 operates on the basis of ultrasound, as is known in air humidifiers. The fog absorbs the ultrafine water droplets in a mixing zone 6 that is formed by a mixing chamber 7 and leaves the apparatus, which is an accessory for the fog machine 1, at an outlet port 8 as a water-enriched, heavy ground fog. Both the fan speed and the quantity of atomized water can be controlled, so that the ground fog can be adapted to requirements. The adjustments are made in such a way that the ground fog does not leave any traces of moisture on a stage or the like. If the fog machine 1 is already equipped with a fan at the outlet, then the fan 2 is omitted, and the atomizer can be mounted directly in the expelled stream of fog. According to FIG. 1, the positioning of the atomizer 3 in the center of the fog airstream is advantageous. Alternatively or in addition, atomizers 3 can also be provided as a ring in the fog airstream.

FIG. 2 shows a variant of an apparatus that is downstream from the fog machine 1. This apparatus has a housing with an inlet port 9 for the fog of the fog machine 1 as well as a second inlet port 10 for suctioning air through a speed-controlled fan 11. An atomizer 12 is provided that is inside the housing and that is connected to a water reservoir (not shown). According to FIG. 2, the atomizer 12 sprays upward, that is, directly into the mixing zone with the inflowing fog and the air being blown in by the fan 11. The area of the housing is referred to as the mixing chamber 13. The water-enriched fog passes into a water separator 14 before it emerges from an outlet port 15. Here, the water separator 14 comprises a plurality of baffles 16 that form a labyrinth for the fog that passes through and removes excess water from the fog. The excess water runs back to the atomizer 12. A cooler 17 for the fog that passes through is also located in the water separator 14 and can be formed by Peltier elements, for example. FIG. 3 shows to an embodiment in which the atomizer 18 is not on the bottom of the mixing chamber 13 (FIG. 2), but rather, as in FIG. 1, directly downstream from an intake fan 19 for fresh air. The fog is united in the mixing chamber 20 with the water droplets from the valve stream. Here, only one baffle 21 for separating excess water is shown schematically. The enriched, heavy fog must rise over this baffle 21, loses water that is not sufficiently bound to the fog molecules in the process, and passes behind the baffle 21 to a lower outlet 22 that can be surrounded by a cooling collar, if anything.

FIG. 4 relates to FIG. 2 but can also be applicable analogously to other embodiments. The two inlets 9 and 10 do not guide the fog stream and the airstream parallel to one another, but rather toward each other at a sharp acute angle, here with a point of intersection in the cloud of water droplets sprayed upward from the atomizer 12. An especially thorough mixing and binding of the ultrafine water droplets to the fog occurs. The water separator 14 ensures that the emerging fog remains enriched with water but loses no excess water so as not to wet the stage, the actors, the audience, or other objects.

In addition, it should be pointed out that the fog and water droplets can also be mixed in counterflow. In FIG. 4, for example, the water atomizer 12 can be aligned obliquely against the incoming fog and against the stream of the fan 11. This also results in an increase in efficiency and better binding of the water droplets to the fog.

1-2. (canceled)

3. An apparatus for making ground fog as an effect, the apparatus comprising:
a housing forming a mixing chamber having two inlet ports and an outlet port;
a fog machine that vaporizes a glycol-based fog fluid and feeds the vaporized fluid as a fog through one of the inlet ports to the mixing chamber downstream of the fog machine;
an ultrasonic water atomizer for creating water droplets and mixing the fog in the mixing chamber with the water droplets;
a fan for conveying ambient air through the other of the inlet ports into the mixing chamber to overpressurize same and force an air stream carrying the fog and water droplets out the outlet port; and
a baffle in the mixing chamber immediately upstream of the outlet port for separating excess water from the air stream before exiting the mixing chamber through the outlet port.

4. The apparatus defined in claim 3, wherein the fog formed in the fog machine is guided into an intake area of the fan in whose overpressure airstream the ultrasonic atomizer is provided in the center of the fan or in the vicinity thereof.

5. (canceled)

6. The apparatus defined in claim 4, wherein the airstream and fog meet one another in the mixing chamber at sharp acute angle in counterflow, and emerge from the mixing chamber on an axis of symmetry thereof as the ground fog.

7. The apparatus defined in claim 3, wherein the ultrasonic atomizer is in the center of the fan that blows water-enriched air into the mixing zone.

8. The apparatus defined in claim 3, further comprising:
a cooler integrated into the mixing zone or downstream from the mixing chamber.

9. The apparatus defined in claim 8, wherein Peltier elements form the cooler and are downstream of the baffle.

10. The apparatus defined in claim 3, wherein there are a plurality of the baffles spaced apart between the mixing chamber and the outlet port.
